(19) United States
(12) Patent Application Publication
(10) Pub. No.: US 2007/0168400 A1
(43) Pub. Date: Jul. 19, 2007

(54) SYSTEM AND METHOD FOR SYNCHRONIZING FILE INDEXES REMOTELY

(75) Inventors: CHUNG-I LEE, Tu-Cheng (TW); CHIEN-FA YEH, Tu-Cheng (TW); DA-PENG LI, Shenzhen (CN); FANG HAN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,139

(22) Filed: Dec. 15, 2006

(30) Foreign Application Priority Data
Jan. 17, 2006 (CN) 200610033275.0

(51) Int. Cl. G06F 17/30

(52) U.S. Cl. 707/201

(57) ABSTRACT

An exemplary method for synchronizing file indexes remotely is disclosed. The method includes the steps of: identifying files that were newly created, modified, or deleted within a time range; reading the modified status of each of the files; parsing data from each of the files that are either of the newly created files or the modified files to create new info files; signaling each of the index servers to create new file indexes corresponding to the new info files; replacing file indexes of the files that are the modified status with the new file indexes of the files in a files indexes list; merging the new file indexes of the files that are the new status into the files indexes list; and removing file indexes of the files that are the deleted status from the files indexes list. A related system is also disclosed.

### BACKGROUND OF THE INVENTION

1. Field of the Invention

The present invention is generally related to systems and methods for synchronizing file indexes, and more particularly to a system and method for synchronizing file indexes remotely.

2. Description of Related Art

In order to quickly search for in-house document data or a home page on the Internet, conventionally, a search index is prepared for character strings that appear in documents that are sought. Therefore, an all-sentences search is conducted to examine all available documents for the desired character string or document based on the search index. The importance of such search index is acknowledged. However, with the amount of data searched increasing, the search index is thereby expanded.

The purpose of an information retrieval (IR) system is to search a database of documents to find the documents that satisfy a user's information need, expressed as a query. Most of the current IR systems convert original text documents into index files, namely creating a file index for each text document. The file index contains information about terms (e.g., words and phrases) that are used for searching the individual documents. With the amount of the index files increasing constantly, an index server is required to periodically update the file indexes created for the text documents stored therein, in order to satisfy users' demands for up-to-date information. Therefore, it is necessary to synchronize the file indexes in the index server in time. However, most of current systems for synchronizing file indexes are configured for synchronizing file indexes in only one index server at a time, thus such systems have a low efficiency for users.

Therefore, what is needed is a system and method for synchronizing file indexes remotely, which is capable of synchronizing file indexes in a plurality of index serves remotely and simultaneously.

### SUMMARY OF THE INVENTION

One embodiment provides a system for synchronizing file indexes remotely. The system includes a database with various files stored therein, a plurality of index servers with the same information, and a synchronization server configured between the database and the index servers. The synchronization server includes a parameter setting module configured for setting parameters in a parameter configuration file of the synchronization server; a file select module configured for identifying files that were newly created, modified, or deleted within a time range from a file history table of the database; a file status reader module configured for reading the modified status of each of the files from the file history table, thus, detecting if each of the files is either of the newly created file, the modified file, or the deleted file; a parser module configured for parsing data from each of the files that are either of the newly created files or the modified files to create new info files that are in a predetermined format; a creating module configured for signaling each of the index servers to create new file indexes corresponding to the new info files; and a synchronizing module configured for signaling each of the index servers to replace file indexes of the files that are the modified status with the new file indexes of the files in a files indexes list of each of the index servers, merge the new file indexes of the files that are the new status into the files indexes list of each of the index servers, and remove file indexes of the files that are the deleted status from the files indexes list of each of the index servers.

Another embodiment provides a computer-based method for synchronizing file indexes remotely. The method includes the steps of: (a) proving a database with various files stored therein, a plurality of index servers with the same information, and a synchronization server configured between the database and the index servers; (b) setting parameters in a parameter configuration file of the synchronization server; (c) identifying files that were newly created, modified, or deleted within a time range from a file history table of the database; (d) reading the modified status of each of the files from the file history table, thus, detecting if each of the files is either of the newly created file, the modified file, or the deleted file; (e) parsing data from each of the files that are either of the newly created files or the modified files to create new info files that are in a predetermined format; (f) signaling each of the index servers to create new file indexes corresponding to the new info files; (g) signaling each of the index servers to replace file indexes of the files that are the modified status with the new file indexes of the files in a files indexes list of each of the index servers; (h) signaling each of the index servers to merge the new file indexes of the files that are the new status into the files indexes list of each of the index servers; and (i) signaling each of the index servers to remove file indexes of the files that are the deleted status from the files indexes list of each of the index servers.

Other objects, advantages and novel features of the embodiments will be drawn from the following detailed description together with the attached drawings, in which:

### BRIEF DESCRIPTION OF THE DRAWINGS

FIG. 1 is a schematic diagram of a hardware configuration of a system for synchronizing file indexes remotely in accordance with a preferred embodiment;

FIG. 2 is a schematic diagram illustrating a file info table in the synchronization server of FIG. 1;

FIG. 3 is a schematic diagram illustrating a file history table in the synchronization server of FIG. 1;

FIG. 4 is a schematic diagram of main function modules of the synchronization server of the system of FIG. 1; and

FIG. 5 is a flow chart of a preferred method for synchronizing file indexes remotely by utilizing the system of FIG. 1.

### DETAILED DESCRIPTION OF THE INVENTION

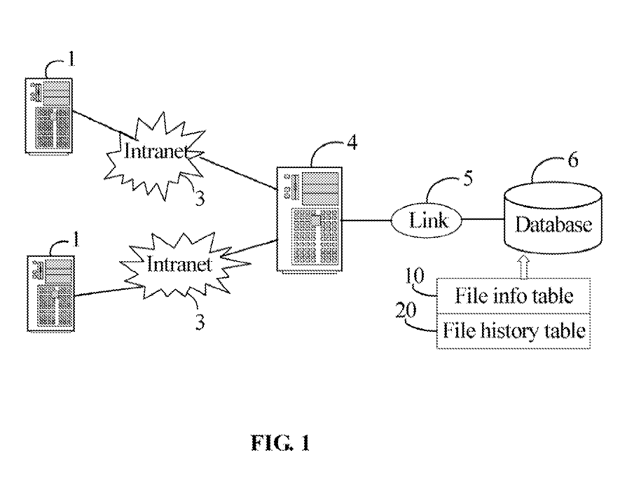

FIG. 1 is a schematic diagram of a hardware configuration of a system for synchronizing file indexes remotely (hereinafter, “the system”) in accordance with a preferred embodiment. The system includes a plurality of index servers 1 (only two shown in FIG. 1), a synchronization server 4, and a database 6. Data in each of the plurality of index servers 1 are the same. The index servers 1 are located at different locations, such as in China and in the United States. Each index server 1 is connected with the synchronization server 4 via an Intranet 3. The synchronization server 4 is connected with the database 6 through a link 5. The link 5 may be an open database connectivity (ODBC), or a Java database connectivity (JDBC).

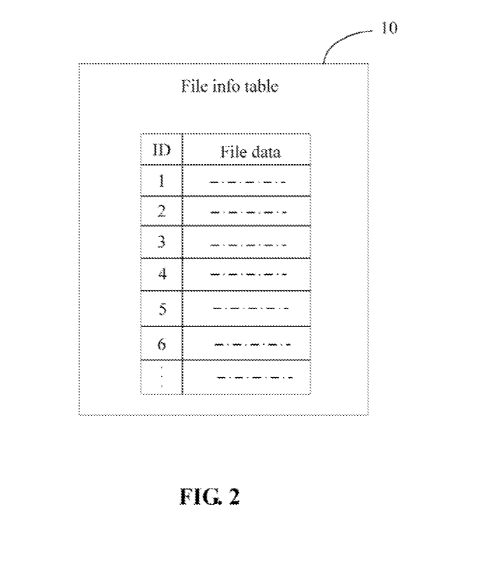

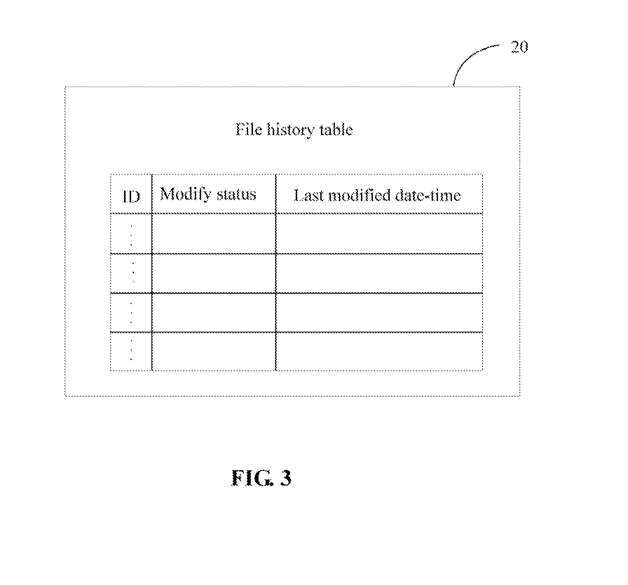

The database 6 is configured for storing patent files, a file info table 10 (shown in FIG. 2), and a file history table 20 (shown in FIG. 3). Each of the patent files in the database 6 is assigned a unique identifier (UID). The file info table 10 contains an info identifier (ID) field (column) and a file data field (column). Each tuple (row) in the file info table 10 stores the UID and the patent data of the patent file in the info ID field and in the file data field respectively. The patent data consists of Title, Claims, Specification, Abstract, Drawings, inventor(s) information, patentee(s) information, an application date, an application number, and so on. The file history table 20 is configured for recording a history data of each of the patent files that were modified within a time range. The file history table 20 contains at least three fields, a history ID field, a modify status field, and a last modified date-time field. Each tuple of the file history table 20 stores the UID, the modify status, and the last modified date-time of the patent file in the history ID field, the modify status field, and the last modified date-time field respectively. A modify status of the patent file may be either of new, modified, or deleted statuses. The new modify status, the modified status, and the deleted status represent whether the patent file is a newly created patent file, modified patent file, or deleted patent file respectively. The last modified date-time of the patent file stores the date and time when the patent file was newly created, modified, or deleted correspondingly.

The synchronization server 4 is configured for identifying modified patent files within the time range, signaling each of the index servers 1 to remove patent file indexes of the deleted patent files from a patents indexes list of each of the index servers 1. The synchronization server 4 is also used for parsing data from the newly created patent files and/or the modified patent files to create new patent info files that are in a predetermined format correspondingly. I.e., the synchronization server 4 creates the new patent info file of the newly created patent file, or creates the new patent info file of the modified patent file based on data parsed. The synchronization server 4 is further used for remotely signaling each of the index servers 1 to create a new patent file index corresponding to the new patent info file. The modified patent files are identified from the file history table 20. Data in the patent info file contains Title, Abstract, inventor(s) information, patentee(s) information, an application date, an application number, and so on. In the preferred embodiment, the predetermined format may be an Extensible Markup Language (XML) file format.

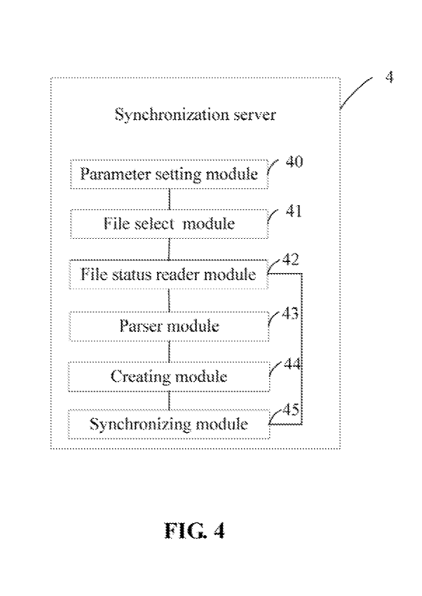

FIG. 4 is a schematic diagram of main function modules of the synchronization server 4. The synchronization server 4 includes a parameter setting module 40, a file select module 41, a file status reader module 42, a parser module 43, a creating module 44, and a synchronizing module 45.

The parameter setting module 40 is configured for setting parameters in a parameter configuration file of the synchronization server 4. The parameter configuration file stores the parameters that may include a last index update time, an index update schedule, and a data path of all patent info files in the synchronization server 4.

The file select module 41 is configured for identifying the patent file(s) that was/were newly created, modified, and/or deleted within the time range, and selecting a first accessed patent file within the time range thereby yielding a selected patent file. The selected patent files are selected in chronological order beginning with a first (oldest) accessed patent file within the time range. The time range may be derived according to the last index update time and the index update schedule. For example, if the last index update time is Jun. 5, 2006, and the index update schedule is four days, the time range is from Jun. 5, 2006 to Jun. 9, 2006.

The file status reader module 42 is configured for reading the modify status of the selected patent file, thus, detecting if the selected patent file is either of the newly created patent file, the modified patent file, or the deleted patent file. In the preferred embodiment, the modify status is read from the file history table 20.

The parser module 43 is configured for parsing data from each of the selected patent files that are either of the newly created patent files or the modified patent files to create a new patent info file that is in the predetermined format based on the data parsed, and for storing the patent info file in the data path of all patent info files. Data in the patent info file contains Title, Abstract, inventor(s) information, patentee(s) information, an application date, an application number, and so on. In the preferred embodiment, the predetermined format may be an Extensible Markup Language (XML) file format.

The creating module 44 is configured for signaling each of the index servers 1 to create a new patent file index corresponding to the new patent info file.

The synchronizing module 45 is configured for signaling each of the index servers 1 to remove the patent file indexes of the deleted patent files from the patents indexes list of each of the index servers 1, replace patent file indexes of the modified patent files with the new patent file indexes of the modified patent files, and merge the new patent file indexes of the newly created patent files into the patents indexes list of each index server 1.

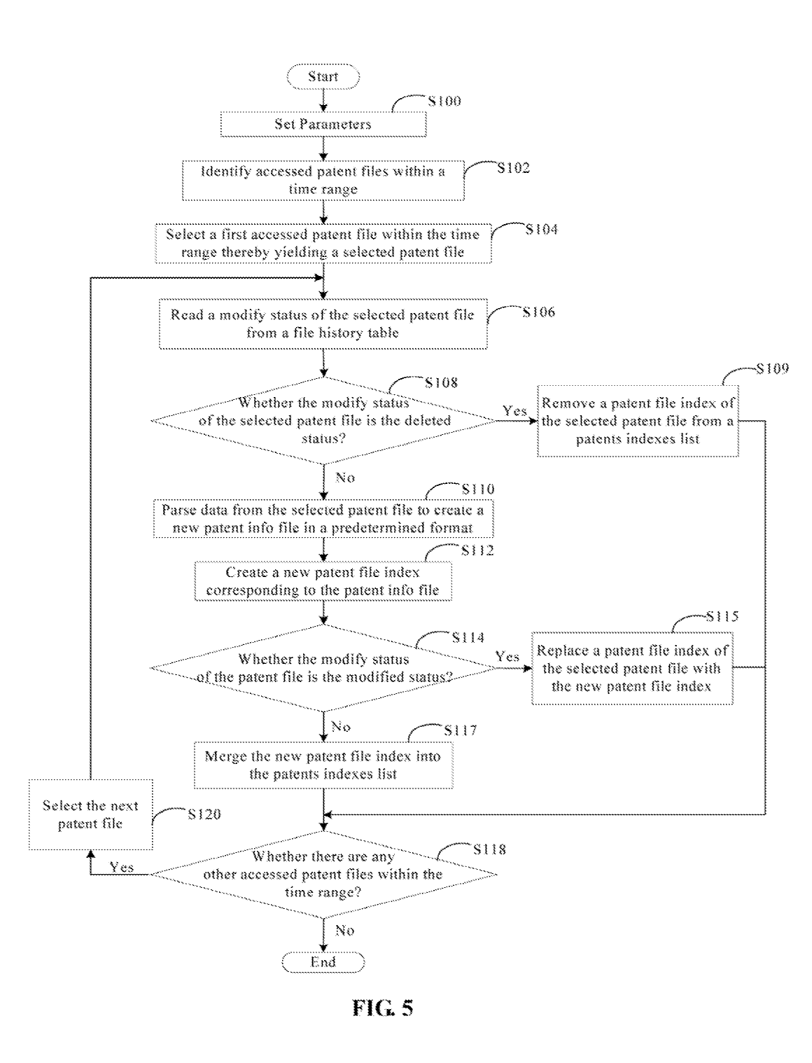

FIG. 5 is a flow chart of a preferred method for synchronizing file indexes remotely by utilizing the system of FIG. 1. In step S100, the parameter setting module 40 sets parameters in the parameter configuration file of the synchronization server 4. The parameter configuration file stores the parameters that may include the last index update time, the index update schedule, and the data path of all info files in the synchronization server 4.

In step S102, the file select module 41 identifies the accessed patent files accessed within the time range. In the preferred embodiment, the accessed patent files are identified from the file history table 20. The time range may be derived according to the last index update time and the index update schedule. For example, if the last index update time is Jun. 5, 2006, and the index update schedule is four days, the time range is from Jun. 5, 2006 to Jun. 9, 2006.

In step S104, the file select module 41 selects the first accessed patent file within the time range thereby yielding a selected patent file. In the preferred embodiment, the accessed patent file is selected in chronological order beginning with the oldest accessed patent file.

In step S106, the file status reader module 42 reads the modify status of the selected patent file. In the preferred embodiment the modify status is read from the file history table 20. The modify status may be either of new, modified, or deleted statuses.

In step S108, the file status reader module 42 detects whether the modify status of the selected patent file is the deleted status.

If the modify status of the selected patent file is the deleted status, in step S109, the synchronizing module 45 signals each of the index servers 1 to remove the patent file index of the selected patent file from the patents indexes list of each of the index servers 1, and the procedure goes to step S118 mentioned below.

If the modify status of the patent file is not the deleted status, in step S110, the parser module 43 parses data from the selected patent file to create the new patent info file that is in the predetermined format based on the data parsed. In the preferred embodiment, the predetermined format may be an Extensible Markup Language (XML) file format. The data in the new patent info file include Title, Abstract, inventor(s) information, patentee(s) information, an application date, an application number, and so on.

In step S112, the creating module 44 signals each of the index servers 1 to create a new patent file index corresponding to the new patent info file.

In step S114, the file status reader module 42 detects whether the modify status of the patent file is the modified status. If the modify status of the patent file is the modified status, in step S115, the synchronizing module 45 signals each of the index servers 1 to replace the patent file index of the selected patent file in the patents indexes list with the new patent file index of selected patent file, and the procedure goes to step S118 mentioned below.

If the modify status of the patent file is not the modified status, this indicates that the modify status of the patent file is the new status, and in step S117, the synchronizing module 45 signals each of the index servers 1 to merge the new patent file index of the selected patent file into the patents indexes list of each of the index servers 1.

In step S118, the file select module 41 detects whether there are any other accessed patent files within the time range. If there are no other patent files, the procedure ends.

If there are other accessed patent files within the time range, in step S120, the file select module 41 selects the next patent file, and the procedure returns to step S106 mentioned above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for synchronizing file indexes remotely, the system comprising a database with various files stored therein, a plurality of index servers with the same information, and a synchronization server configured between the database and the index servers, the synchronization server comprising:
a parameter setting module configured for setting parameters in a parameter configuration file of the synchronization server;
a file select module configured for identifying files that were newly created, modified, or deleted within a time range from a file history table of the database;
a file status reader module configured for reading the modified status of each of the files from the file history table, thus, detecting if each of the files is either of the newly created file, the modified file, or the deleted file;
a parser module configured for parsing data from each of the files that are either of the newly created files or the modified files to create new information files that are in a predetermined format;
a creating module configured for signaling each of the index servers to create new file indexes corresponding to the new information files; and
a synchronizing module configured for signaling each of the index servers to replace file indexes of the files that are the modified status with the new file indexes of the files in a files indexes list of each of the index servers, merge the new file indexes of the files that are the new status into the files indexes list of each of the index servers, and remove file indexes of the files that are the deleted status from the files indexes list of each of the index servers.

2. The system according to claim 1, wherein the predetermined format is an Extensible Markup Language (XML) file format.

3. The system according to claim 1, wherein the parameter configuration file stores the parameters that comprise a last index update time, an index update schedule, and a data path of all info files in the synchronization server.

4. The system according to claim 3 wherein the time range is derived according to the last index update time and the index update schedule.

5. The system according to claim 1, wherein the file history table is configured for recording history data of each of the files in the database that are newly created, modified or deleted within the time range.

6. The method according to claim 5, wherein the file history table contains three fields that are a history identifier field, a modify status field and a last modified date-time field.

7. A computer-based method for synchronizing file indexes remotely, the method comprising the steps of:
proving a database with various files stored therein, a plurality of index servers with the same information, and a synchronization server configured between the database and the index servers;
setting parameters in a parameter configuration file of the synchronization server;
identifying files that were newly created, modified, or deleted within a time range from a file history table of the database;
reading the modify status of each of the files from the file history table, thus, detecting if each of the files is either of the newly created file, the modified file, or the deleted file;
parsing data from each of the files that are either of the newly created files or the modified files to create new information files that are in a predetermined format;
signaling each of the index servers to create new file indexes corresponding to the new information files;
signaling each of the index servers to replace file indexes of the files that are the modified status with the new file indexes of the files in a files indexes list of each of the index servers;
signaling each of the index servers to merge the new file indexes of the files that are the new status into the files indexes list of each of the index servers; and
signaling each of the index servers to remove file indexes of the files that are the deleted status from the files indexes list of each of the index servers.

8. The method according to claim 7 wherein the predetermined format is an Extensible Markup Language (XML) file format.

9. The method according to claim 7 wherein the parameter configuration file stores the parameters that may include a last index update time, an index update schedule, and a data path of all info files in the synchronization server.

10. The method according to claim 9, wherein the time range is derived according to the last index update time and the index update schedule.

11. The method according to claim 7, wherein the file history table is configured for recording history data of each of the files that are newly created, modified or deleted within the time range.

12. The method according to claim 11, wherein the file history table contains three fields that are a history identifier field, a modify status field and a last modified date-time field.
